(19) United States
(12) Patent Application Publication
(10) Pub. No.: US 2026/0371202 A1
(43) Pub. Date: Nov. 19, 2026

(54) DEVICES AND METHOD FOR CONFIGURATION OF USER DEVICE DURING SMALL DATA TRANSMISSION

(71) Applicant: HUAWEI TECHNOLOGIES CO., LTD., Shenzhen (CN)

(72) Inventors: Jagdeep Singh Ahluwalia, Reading (GB); Haibo Xu, Beijing (CN); Mengchen Zhang, Beijing (CN)

(73) Assignee: HUAWEI TECHNOLOGIES CO., LTD., Shenzhen (CN)

(21) Appl. No.: 19/573,775

(22) Filed: Mar. 20, 2026

Related U.S. Application Data
(63) Continuation of application No. PCT/CN2023/120432, filed on Sep. 21, 2023.

(51) Int. Cl. H04W 36/18; H04W 36/00; H04W 76/19; H04W 76/20; H04W 76/30

(52) U.S. Cl. CPC H04W 36/18; H04W 36/0033; H04W 76/19; H04W 76/20; H04W 76/30

(57) ABSTRACT

A network device configured to operate as a source node for a user device which has transitioned from the source node to a target node during an ongoing communication session in a communications network, the source node configured to transmit an indication to the target node wherein the indication indicates that the source node will remain as being an anchor node for the user device during the ongoing communication session. The modification to existing procedures over Uu, F1, E1 and Xn interface makes the present disclosure suitable for supporting anchoring functionality during multishot SDT.

### CROSS-REFERENCE TO RELATED APPLICATIONS

This application is a continuation of International Application No. PCT/CN2023/120432, filed on Sep. 21, 2023, the disclosure of which is hereby incorporated by reference in its entirety.

### FIELD OF THE INVENTION

This invention relates to providing a user device with configuration information while preforming small data transmission, and particularly, to providing the user device with the configuration information dedicated for performing small data transmission anchoring and security key handling.

### BACKGROUND

In communications or mobile communication systems different protocols are used for performing certain actions within the communication or mobile communication system. For example, when a user device is connected to a communication or mobile communication network it is typically associated with a single node of the network. Messages can then be sent from the user device to core nodes of the network via that specific node to which the user device is directly connected.

Typically, the plurality of nodes which make up the communication or mobile communication network are stationary, whereas the user device can roam within the coverage area of the network nodes. When the user device moves its location within the network it may move from the coverage area of one node of the network to the coverage area of another node of the network. When the user device changes its location in this way it thus must also change which node of the network it is associated with through which it will continue to communicate with the network core nodes. Such a transfer is typically called a handover or cell reselection.

If a user device is required to handover from one node to another node a series of messages must be exchanged with the network such that the user device can maintain a connection with the network at all times. A delay in this process can cause a noticeable lag for the user when attempting to obtain data from the network via the user device. This is particularly important during ongoing communication sessions where the continuity of the data being transmitted must be maintained. For example, during VoIP calls or data transfers comprising multiple packets of data.

User devices typically have a plurality of modes in which they can function or operate. These modes may dictate the state of the communication of the user device with the network. At certain times a user device can operate in an inactive mode to reduce power consumption. In this mode the activity of certain parts of the user device can be minimized as they are not expected to be needed in the near future.

Typically, a user device does not transmit data packets while in an inactive mode, which is also referred to herein as an RRC_INACTIVE mode. However, in the inactive mode the user device can autonomously perform Cell Reselection while roaming freely within the coverage area of the network, for example a RAN Based Notification Area.

The user device context may comprise the parameters used for configuration of the Layer 3 (Radio Resource Control (RRC)) Layer 2 (Service Data Adaptation Protocol (SDAP), Packet Data Convergence Protocol (PDCP), Radio Link Control (RLC), Medium Access Control (MAC)), Physical Layer Parameter, Access Stratum Security Context, Number of Protocol Data Unit (PDU) Session, Number of Signaling and Data Radio Bearers for the UE.

Prior art systems are often focused on supporting single shot (one packet) transmission during the SDT. However, to support multi shot SDT there are number of factors that need to be taken into account. This is because the multi shot procedure design may be more complex and may require additional information exchange between the UE and the network to efficiently support multi shot SDT procedure. Furthermore, the security key separation is to be ensured during this procedure so that the security keys are not shared among the nodes

It is desirable to optimise user device resources used in ongoing communication sessions, either while maintaining location or during transfer or handover procedure, to exploit existing procedures for small data transmission anchoring and security key handling.

### SUMMARY

According to a first aspect there is provided a network device configured to operate as a source node for a user device which has transitioned from the source node to a target node during an ongoing communication session in a communications network, the source node configured to transmit an indication to the target node, wherein the indication indicates that the source node will remain as being an anchor node for the user device during the ongoing communication session. In this way, the network device will not come out of the anchor mode when the user is in the new, or transitioned, node location.

In some implementations, the network device may be configured wherein the source node is configured to generate the indication as a part of a retrieved user device context response message transmitted from the source node to the target node. In this way, the control the anchor node for the user device may be included in the context about the user device.

In some implementations, the network device may be configured wherein the source node is configured to generate the indication as a Boolean flag within the retrieved user device context response message.

In some implementations, the network device may be configured wherein the source node is configured to generate the indication as a part of a downlink radio resource control, RRC, small data transmission, SDT, reconfiguration message within the retrieved user device context response message.

In some implementations, the network device may be configured wherein the source node is configured to generate the radio resource control, RRC, SDT reconfiguration message comprising reserved or new inactive Radio Network Temporary Identifier, RNTI, I-RNTI, and next hop chaining counter, NCC, to be received by the user device via the target node.

In some implementations, the network device may be configured wherein the source node is configured to generate and transfer an RRC message or a non-access stratum, NAS message as a part of a retrieved user device context response message to the target node during a SDT communication session.

In some implementations, the network device may be configured wherein the source node is configured to terminate the ongoing communication session based on receiving from the user device either assistance information or an indication that the SDT communication session has been completed. In this way, the source node may terminate the communication session when the SDT communication session is completed.

In some implementations, the network device may be configured wherein the source node is configured to terminate the ongoing communication session by generating a SDT RRC transfer message and transmitting the SDT RRC transfer message to the target node.

In some implementations, the network device may be configured wherein the SDT RRC transfer message comprises an RRC release message comprising a new NCC and I-RNTI for a further SDT communication session. In this way, when the SDT communication session is terminated, the network may be configured ready for a further SDT communication session.

According to a second aspect there is provided a network device configured to operate as a source node for a user device which has transitioned from the source node to a target node during an ongoing communication session in a communications network, wherein the source node is configured to receive an indication that the source node cannot remain as being an anchor node of the ongoing communication session and, in response to receiving the indication, to cause the user device to transition from an inactive state to an active state and relocate user device context from the source node to the target node. In this way, the source node will not remain as the anchor node.

In some implementations, the network device may be configured wherein the source node is configured to, in response to receiving the indication, generate at least one new key for the target node to continue the ongoing communication session as the anchor node. In this way, the new key may provide security to the target node as being the anchor node.

In some implementations, the network device may be configured wherein the ongoing communication session in a communications network is implemented via a small data transmission, SDT, procedure and the indication indicates that the ongoing communication session cannot continue as an SDT communication session.

In some implementations, the network device may be configured wherein the source node is configured to generate and transmit to the target node the at least one new key as a part of a radio resource control, RRC, small data transmission, SDT, reconfiguration message encoded with the currently used and/or derived key.

In some implementations, the network device may be configured wherein the source node is configured to generate the uplink RRC SDT reconfiguration message as part of a user device context transfer request message transmitted to the target node.

In some implementations, the network device may be configured wherein the source node is configured to receive the indication as an SDT transfer message or RRC Transfer Message comprising a dedicated control channel, DCCH, message or as a retrieve user device context message comprising an indication of uplink non-SDT data arrival or deteriorating transmission conditions.

In some implementations, the network device may be configured wherein the source node is configured to receive the indication as an SDT transfer message or RRC Transfer message comprising a common control channel, CCCH, message indicating the need to send non-SDT uplink data or uplink non-access stratum, NAS, message arrival at the user device.

In some implementations, the network device may be configured wherein the source node is configured to generate and transmit a user device context transfer request or retrieve user device context response message comprising user context to the target node.

In some implementations, the network device may be configured wherein the source node is configured to receive a user device context transfer response message comprising a transport network layer, TNL address for establishing forwarding tunnels for the non-SDT data.

In some implementations, the network device may be configured wherein the source node is configured to receive the indication that the source node cannot remain the anchor node of the ongoing communication session and in response terminate the current SDT procedure. In this way, when the source node is no longer the anchor node, the SDT procedure may be terminated.

In some implementations, the network device may be configured wherein the source node is configured to generate and transmit an SDT RRC transfer message or user device context failure message to the target node comprising an indication to initiate a new resume request message. The indication may also indicate to not suspend and reestablish PDCP entities configured for SDT bearers.

In some implementations, the network device may be configured wherein the SDT RRC transfer request message comprises new NCC and I-RNTI for a further SDT session.

In some implementations, the network device may be configured wherein, in response to receiving a retrieve user device context request from the target node, the source node is configured to initiate relocation of the user device context and transmit an indication of downlink non-SDT data and uplink PDCP status reports to the target node.

According to a third aspect there is provided a network device configured to operate as a target node for a user device which has transitioned from a source node to the target node during an ongoing communication session in a communications network, wherein the target node is configured to receive an indication from the source node that the source node will remain as being an anchor node of the ongoing communication session. In this way, even when the user device transitions, the source node may remain as being the anchor node.

In some implementations, the network device may be configured wherein the target node is configured to receive the indication as a part of a retrieve user device context response message transmitted from the source node to the target node.

In some implementations, the network device may be configured wherein the target node is configured to forward the retrieve user device context response message, as received from the source node to the user device. In this way, the Downlink RRC Message such as RRC SDT Reconfiguration/RRC Release message contained in the retrieve user device context response message may be transferred from the source node, through the target node, to the user device.

In some implementations, the network device may be configured wherein the target node is configured to: receive an small data transmission, SDT radio resource control, RRC transfer message comprising an RRC release message comprising a new next hop chaining counter NCC and inactive Radio Network Temporary Identifier I-RNTI for a further SDT communication session; and forward the RRC release message to the user device.

In some implementations, the network device may be configured wherein the source node is configured to generate and transfer an RRC message or a non-access stratum NAS message as a part of a new interface message to the target node during a SDT communication session.

According to a fourth aspect there is provided a network device configured to operate as a target node for a user device which has transitioned from a source node to the target node during an ongoing communication session in a communications network, the target node being configured to receive an indication from the source node that the source node cannot remain as being an anchor node of the ongoing communication session

In some implementations, the network device may be configured wherein the target node is configured to forward a radio resource control, RRC small data transmission, SDT reconfiguration message received from the source node to the user device encrypted with at least one currently used security key.

In some implementations, the network device may be configured wherein the target node is configured to receive a RRC SDT reconfiguration complete message from the user device encrypted with at least one new security key.

In some implementations, the network device may be configured wherein the target node is configured to receive an indication from the source node that the SDT session will be terminated.

In some implementations, the network device may be configured wherein the target node is configured to transmit to the user device an indication to initiate a new RRC resume procedure and to receive an RRC resume request message from the user device in response.

In some implementations, the network device may be configured wherein the target node is configured to generate an RRC resume message to be transmitted to the user device comprising an indication not to re-establish packet data convergence protocol, PDCP, entities, or an indication to not discard PDCP service data units, SDUs for the SDT bearers, first missing uplink PDCP sequence numbers SNs or uplink PDCP status report for SDT bearers.

In some implementations, the network device may be configured wherein the target node is configured to generate and transmit an Xn-U address indication message in response to receiving an RRC resume complete message from the user device, the Xn-U address indication message comprising the address for establishing downlink SDT or non-SDT data forwarding tunnels.

According to a fifth aspect there is provided a user device configured to receive an indication from a target node when transitioning from a source node to the target node during an ongoing communication session, the indication indicating that the source node will remain as being an anchor node of the ongoing communication session.

In some implementations, the user device may be configured wherein the user device is configured to receive a radio resource control, RRC small data transmission, SDT reconfiguration message, the RRC SDT reconfiguration message comprising reserved inactive Radio Network Temporary Identifier, I-RNTI and reserved next hop chaining counter, NCC values.

According to a sixth aspect there is provided a user device configured to transmit an indication to a target node when transitioning from a source node to the target node during an ongoing communication session, the indication indicating that the source node cannot remain as being an anchor node of the ongoing communication session.

In some implementations, the user device may be configured wherein the user device is configured to receive at least one new security key in a radio resource control, RRC small data transmission, SDT reconfiguration message for use by the user device when communicating with the target node.

In some implementations, the user device may be configured wherein the user device is configured to receive an indication to initiate a new RRC resume procedure from the target node and in response initiate the RRC resume procedure by transmitting an RRC resume request message to the target node.

In some implementations, the network device may be configured wherein the user device is configured to generate and transmit an RRC resume complete message comprising the first missing downlink PDCP SNs or downlink PDCP status report for the SDT bearers to the target node.

### BRIEF DESCRIPTION OF THE FIGURES

The present invention will now be described by way of example with reference to the following accompanying drawings.

FIG. 1 shows a communication flow between a user equipment, a target node, and a source node in a first scenario or embodiment.

FIG. 2 shows a communication flow between a user equipment, a target node, and a source node in a second scenario or embodiment.

FIG. 3 shows a communication flow between a user equipment, a target node, and a source node in a third scenario or embodiment.

FIGS. 4 and 5 show schematic diagrams of the internal structure of a distributed network device which may be configured to operate as a target node or a source node.

### DETAILED DESCRIPTION

The present invention aims at addressing the issues with the signaling involved while anchoring i.e. without anchor relocation cases for multishot SDT procedure and especially the way the RRC messages are to be exchanged during Anchoring during SDT procedure.

The present invention may update the security keys during the ongoing SDT session (due to the relocation of the UE context during an ongoing SDT session after it was anchored). The new procedure may be required to support the key change involving: to provide new NCC to the UE, suspend data transfer, resetting L2, re-establish PDCP, Resume data transfer.

The present invention may include the introduction of new procedures and the modification for existing procedures over Uu and Xn interface to support multishot SDT with different keys being used among the receiving and the last serving gNBs even for the case where the relocation need to be performed after the last serving gNB initially decides to anchor the UE.

The existing approaches have been more focused on supporting Single Shot (one packet) transmission during the Small Data Transmission. To support Multi Shot SDT there are number of additional factors that need to be taken into account as the multishot SDT procedure design is more complex and would require additional information exchange between the UE and the network to efficiently support a multishot SDT procedure. All of these above described issues are addressed by the proposed approach presented herein.

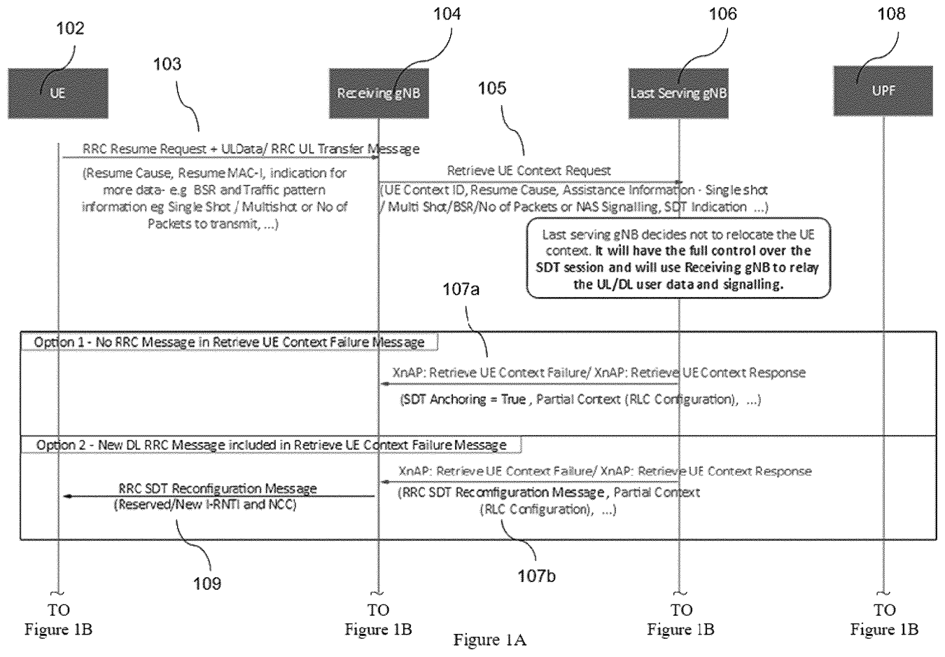

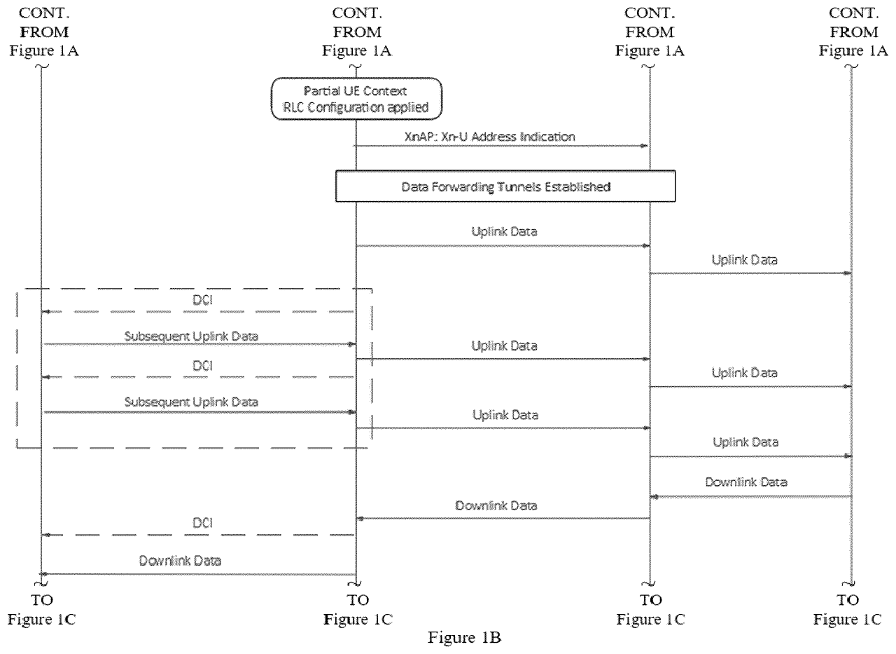

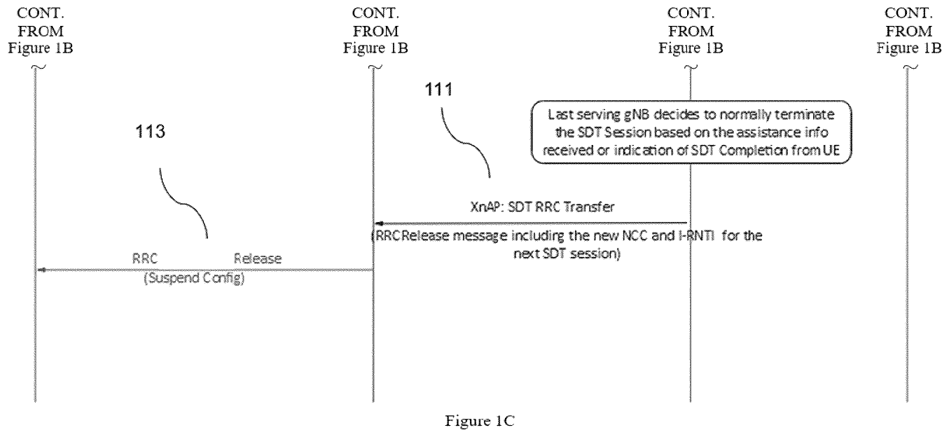

FIG. 1 shows a communication flow between a user equipment (UE) 102, a target g Node B (gNB) 104, and a source g Node B (gNB) 106. The g Node Bs may be a base station or other network device. The user equipment may also be referred to herein as a user device. The network device may be referred to herein as a target node or a source node depending on whether the user device is transferring to or from that network device respectively as part of a Cell Reselection or handover procedure.

In particular, FIG. 1 shows the communication flow with a multi shot non-anchor relocation.

In the example situation of FIG. 1 the designation of a non-anchor relocation case for the communication session. The source node 106 may decide to anchor the communication and not relocate the UE context to the target node 104. The user device context including L3, L2, L1 configuration of the UE is kept in the source node 106.

The anchor node may decide to build and send an RRC downlink message 109 which can carry a range of optional information that can be used by the user device 102 to help set up the SDT session including NCC information and I-RNTI information. This information may later be used by the user device 102 while sending a CCCH RRC Resume Request message to indicate to the network when the UL non-SDT data arrives. In this exemplary embodiment, this RRC downlink message 109 may additionally include any configuration data specifying parameters of the user device 102 to be used during the SDT procedure. Transmission of such dedicated configuration information to the user device 102 while it is in an inactive mode enables power consumption at the user device to be maintained at a minimum.

The source node 106 may be the node that currently holds the UE context during the SDT session. The target node 104 may by the node to which the UE context is to be relocated during the transition of the user device 102 from the source node 106 to the target node 104. The source node 106 may perform processing of a radio resource control, RRC, messages. The source node 106 may perform the key management. The target node 104 may act as a relay to transfer the signalling and data between the UE and the anchor node doing the SDT session. The decision to relocate the context or not may be determined by the anchor node. This decision may be based on indication from the user device transferred through the target node or from the target node itself. The UE can provide the assistance information and this information can be transferred from the target node 104 to the anchor node to decide whether to relocate the context or not.

The source node 106 may be configured to generate the indication as a part of a retrieved user device context response message 107 transmitted from the source 106 node to the target node 104. In other words, the retrieved user device context response message 107 may comprise the indication.

The source node 106 may be configured to generate the indication as a Boolean flag within the retrieved user device context response message 107. In other words, the retrieved user device context response message 107 may comprise a Boolean flag indication.

The source node 106 may be configured to generate the indication as a part of a downlink radio resource control, RRC, small data transmission, SDT, reconfiguration message 107 within the retrieved user device context response and/or failure message. In other words, the embedded RRC SDT reconfiguration message may comprise the indication.

Additionally, or alternatively, the retrieved user device context response message 107 may be and/or include an RRC SDT reconfiguration message.

The source node 106 may be configured to generate the downling radio resource control, RRC, SDT reconfiguration message 107 to be received by the user device 102 via the target node 104. The radio resource control, RRC, SDT reconfiguration message 107 may comprise a reserved or new inactive Radio Network Temporary Identifier, RNTI, I-RNTI, and a next hop chaining counter, NCC.

The retrieved user device context response message 107 may comprise two options as shown in FIG. 1.

In option 1, if no RRC Message is included in XnAP: Retrieve UE Context Failure or XnAP: Retrieve UE Context Response Message 107a then an explicit indication such as “SDT Anchoring =True” is included to indicate that the last serving gNB is anchoring the SDT session or implicit indication such as “Partial Context (RLC Configuration)” included in Retrieve UE Context Failure Message is included.

In option 2, if a RRC Message, RRC SDT Resume/RRC SDT Reconfiguration is included then a Retrieve UE Context Failure Message is included. This message need not terminate the SDT procedure (as RRCRelease messages does) and may allow the UE to perform Subsequent Data transmissions after the New DL RRC SDT Resume/RRC SDT Reconfiguration message. This new message may also contain reserved I-RNTI and NCC or other configuration parameters that could be used by the UE during the SDT session if needed.

The source node 106 may be configured to terminate the ongoing communication session, i.e. the SDT session, based on receiving from the user device 102 either assistance information or an indication that the SDT communication session has been completed. The assistance information may include buffer status report, BSR, and traffic pattern information, for example Single Shot/Multi shot or the number of packets to transmit. The indication that the SDT has been completed may include an empty buffer status report, or end marker packet or release assistance information (RAI) sent to the target node 104. Such indications may be signalled from the target node 104 to the source node 106 through the new Xn AP message such as XnAP: SDT Completion request message.

The source node 106 may be configured to terminate the ongoing communication session by generating a SDT RRC transfer message 111 and transmitting the SDT RRC transfer message to the target node 104. The SDT RRC transfer message 111 may comprise an RRC release message comprising a RRCRelease message with a new NCC and I-RNTI for a further SDT communication session.

The source node 106 may also be configured to generate and transfer an RRC message or a non-access stratum, NAS message embedded in RRC message and included in SDT RRC transfer message to the target node 104 during a SDT communication session.

With the network of FIG. 1, if an RRC message is included then there may be no requirement to buffer the RRC release message in the target mode 104 to handle multishot transmissions and any complications that arise due to this. For example after sending the RRC Release Message, the SDT session may be considered terminated from last serving gNB's point of view and it may discard any subsequent UL packets that are sent from the receiving gNB or may not forward any DL packet to the UE.

At the end of a SDT session the target node 104 may send an RRC release message. Accordingly, the SDT procedure may then end.

Alternatively, the network device may be configured to operate as a target node 104 for a user device 102 which has transitioned from a source node 106 to the target node 104 during an ongoing communication session in a communications network. The target node 104 may be configured to receive an indication from the source node 106 that the source node 106 will remain as being an anchor node of the ongoing communication session.

The target node 104 may be configured to receive the indication as a part of a retrieve user device context response message 107 transmitted from the source node to the target node.

The target node 104 may be configured to forward the RRC message included in retrieve user device context response or failure message 107, as received from the source node 106, to the user device 102.

The target node 104 may be configured to receive an SDT RRC transfer message 111 comprising an RRC release message comprising a new next hop chaining counter NCC and inactive Radio Network Temporary Identifier I-RNTI for a further SDT communication session. The RRC release message may be forwarded to the user device 102 by a RRC release message 113.

The source node 106 may be configured to generate and transfer an RRC message or a non-access stratum NAS message contained in RRC message as a part of a new interface message to the target node during a SDT communication session.

The user device 102 may be configured to receive an indication from a target node 104 when transitioning from a source node 106 to the target node 104 during an ongoing communication session. The user device 102 may be configured to receive a radio resource control, RRC small data transmission, SDT reconfiguration message The RRC SDT reconfiguration message 107 may comprise reserved inactive Radio Network Temporary Identifier, I-RNTI and reserved next hop chaining counter, NCC values.

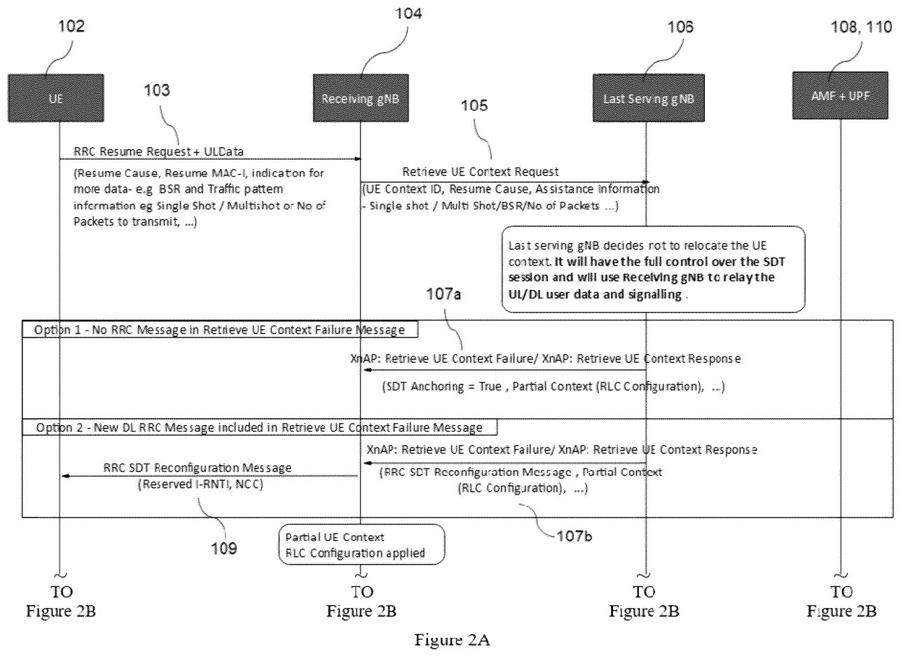

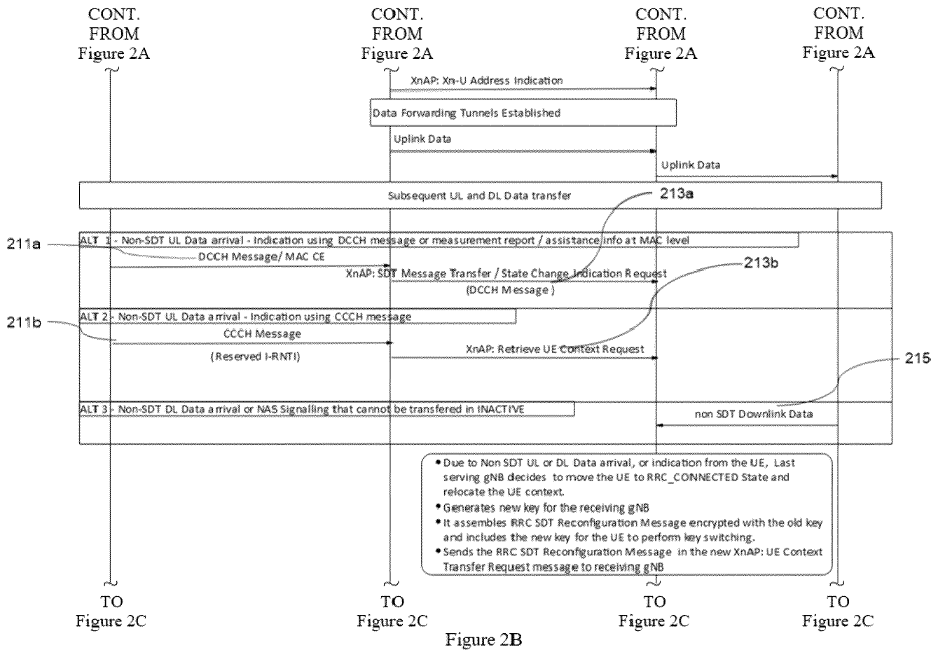

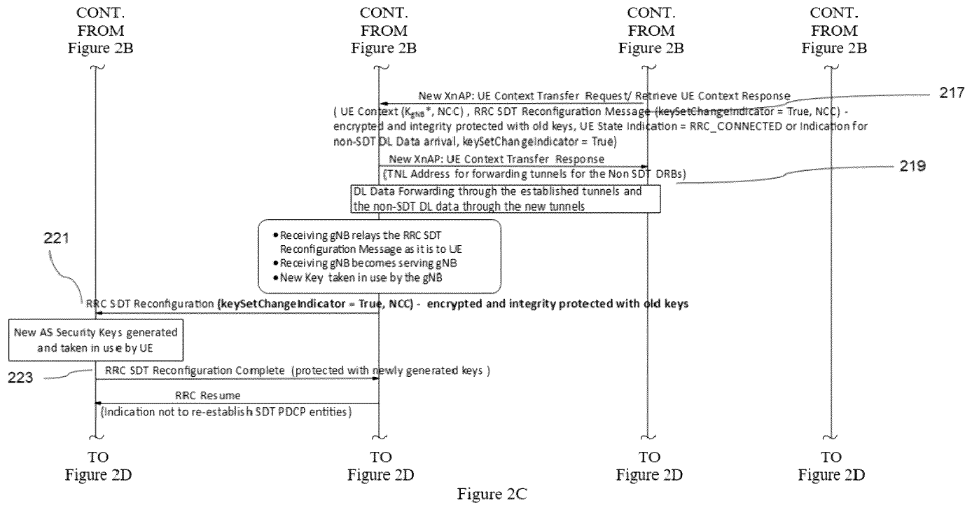

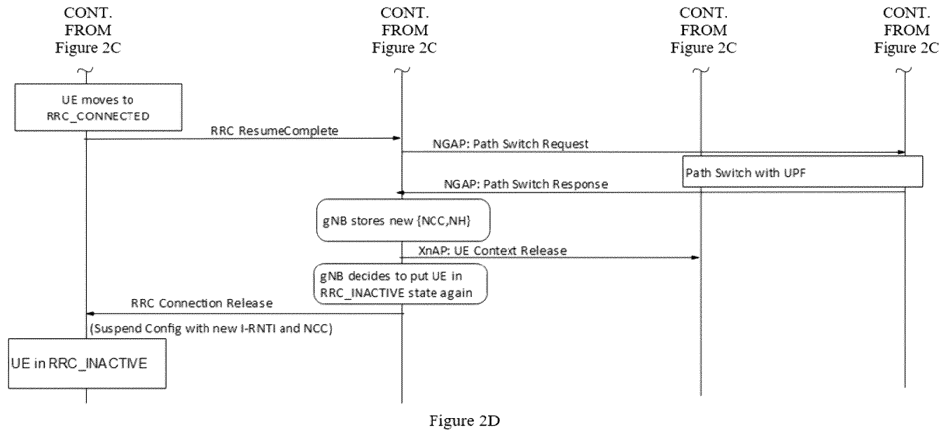

FIG. 2 shows an alternative communication flow between a user equipment (UE) 102, a target g Node B (gNB) 104, and a source g Node B (gNB) 106 for a similar example situation to that of FIG. 1. The network device may be referred to herein as a target node 104 or a source node 106 depending on whether the user device 102 is transferring to or from that network device respectively as part of a Cell Reselection or handover procedure.

In particular, FIG. 2 shows the communication flow with a multi shot non-anchor relocation followed by an anchor relocation.

The network device may be configured to operate as a source node 106 for a user device 102 which has transitioned from the source node 106 to a target node 104 during an ongoing communication session in a communications network. The source node 106 may be configured to receive an indication that the source node 106 cannot remain as being an anchor node of the ongoing communication session. The indication may be received from the target node 104. In response to receiving the indication, to cause the user device 102 to transition from an inactive state to an active state and relocate user device 102 context from the source node 106 to the target node 104.

The source node 106 may configured to generate at least one new key for the target node 104 to continue the ongoing communication session as the anchor node. Generation of the at least one new key may be in response to receiving the indication. The new key may be a previously unused key. The transition of the user device 102 from an inactive state to an active state may be carried out concurrently with the generation of the at least one new key.

The ongoing communication session in the communications network may implemented via a SDT procedure. In this way, the indication received by the user device 102 may indicate that the ongoing communication session cannot continue as an SDT communication session.

The source node 106 may configured to generate and transmit to the target node 104 the at least one new key as a part of an RRC SDT reconfiguration message 107 encoded with the currently used and/or derived key. In other words, the downlink RRC SDT reconfiguration message 107 may comprise the at least one new key. The downlink RRC SDT reconfiguration message 107 may additionally or alternatively be encoded with the currently used and/or derived key, i.e., the key corresponding to the current AS key used between the anchor node and the user device 102.

The source node 106 may be configured to generate the downlink RRC SDT reconfiguration message 107 as part of a user device context transfer request message transmitted to the target node 104. In other words, the user device context transfer request message may comprise the RRC SDT reconfiguration message 107.

The source node 106 is configured to receive the indication as an SDT transfer message or RRC Transfer Message 213 comprising a dedicated control channel, DCCH, message 213a or as a retrieve user device context message 215 comprising an indication of uplink non-SDT data arrival or deteriorating transmission conditions or the cell or target node load conditions.

The source node 106 may be configured to receive the indication as an SDT transfer message or RRC Transfer Message 213 comprising a common control channel, CCCH, message elements or as a retrieve user device context message indicating message 213b indicating the need to send non-SDT uplink data or uplink non-access stratum, NAS, message arrival at the user device 102.

The source node 106 may be configured to generate and transmit a user device context transfer request or retrieve user device context response message 217 comprising user context to the target node 104.

The source node 106 may be configured to receive a user device context transfer response message 219 or Xn-U Address Indication message comprising a transport network layer, TNL address. The TNL address may be used for establishing forwarding tunnels for the non-SDT data. The user device context transfer response message 219 may be received in response to user device context transfer request or retrieve user device context response 217.

Alternatively, the network device may be configured to operate as a target node 104 for a user device 102 which has transitioned from a source node 106 to the target node 104 during an ongoing communication session in a communications network. The target node 104 may be configured to receive an indication from the source node 106 that the source node cannot remain as being an anchor node of the ongoing communication session.

The target node 104 may be configured to forward a radio resource control, RRC SDT reconfiguration message 221 received from the source node 106 to the user device 102. The RRC SDT reconfiguration message 221 may be encrypted with at least one currently used and/or derived Access Stratum AS security keys.

The target node 104 may be configured to receive a RRC SDT reconfiguration complete message 223 from the user device 102. The RRC SDT reconfiguration complete message 223 may be encrypted with at least one new and/or newly derived AS security keys.

The user device 102 may be configured to transmit an indication to the target node 104 when transitioning from a source node 106 to the target node 104 during an ongoing communication session. The indication may indicate that the source node 106 cannot remain as being an anchor node of the ongoing communication session. The user device 102 may be configured to receive at least one new security key in the RRC SDT reconfiguration message 223. The user device 102 may use at least one new security key when communicating with the target node 104. In other words, the user device 102 may not know which node, of the target node 104 and the source node 106 remains the anchor. Instead, the current anchor may decide based on the indications received from the user device 102 or the target node 104. This decision may be based on the UL non-SDT data arrival, deteriorating radio conditions or if the non-SDT DL data arrives in the anchor. The non-SDT data may not be limited to user plane data but may also include NAS signaling that cannot be carried in inactive state using SDT mechanism.

During the procedure described in FIG. 2, the anchor gNB (node) may have full control of the SDT session and the receiving gNB (node) mainly acts as the relay to transfer the signaling and the data between the UE and the last serving gNB (anchor gNB) until the context is transferred.

Due to the following events, the last serving gNB, while anchoring, may decide to relocate the context to the receiving gNB (i) non SDT UL Data or UL NAS message arrival which cannot be transferred using SDT or due to deterioration of radio conditions during SDT and the indication through DCCH message or MAC CE message, (ii) non SDT UL Data arrival and the indication through CCCH or MAC CE message, (iii) Non-SDT DL Data or NAS Signalling arrival, or (iv) due to internal triggers in the target node such as change in radio conditions or cell load in the current cell.

The data and signaling between the UE and the last serving gNB may be encrypted and integrity protected using AS keys derived based on the NCC supplied in the RRC Release message in the previous SDT session until that the last serving gNB decided to bring the UE to RRC Connected mode and relocate the context to receiving gNB. When the Last Serving gNB (Anchor gNB) decides to relocate the context and bring the UE to RRC_CONNECTED, it may transfer the UE context to the Receiving gNB along with new key KgNB* to be used after relocation using the New XnAP: UE Context Transfer message or the old XnAP: Retrieve UE Context Response message.

At the same time the last serving gNB/source node may also generate the RRC SDT reconfiguration message, which is encrypted, and integrity protected using the AS Keys that are currently in use by source node. This message contains the NCC for the UE to derive new AS keys based on NCC and perform key change. This message may be transparently transmitted to the UE by the receiving gNB. In this way, the source node may perform the context transfer with the new keys to target node and the key change for the UE at the same time.

After this, the new AS key may be used by the UE and the receiving gNB which also takes the role of the serving gNB. In this way, old key may not be shared with between the gNBs. In this way, there may not be a security issue as only the new keys are provided to the receiving gNB. The new serving gNB then initiates the RRC Resume procedure towards the UE as usual.

A possible benefit for using a separate procedure for the key change is that it may be extended to other scenarios in which the keys change is needed during the SDT procedure. For example, this may be when the last serving gNB after anchoring decides to relocate the context to the receiving gNB while keeping the UE in RRC_INACTIVE state.

Additionally, a new DL RRC SDT Resume/RRC SDT Reconfiguration message may be a general reconfiguration message used during SDT and can carry any signaling from the network to the UE during SDT procedure including the System Information Block in response to the SIB Request made by the UE.

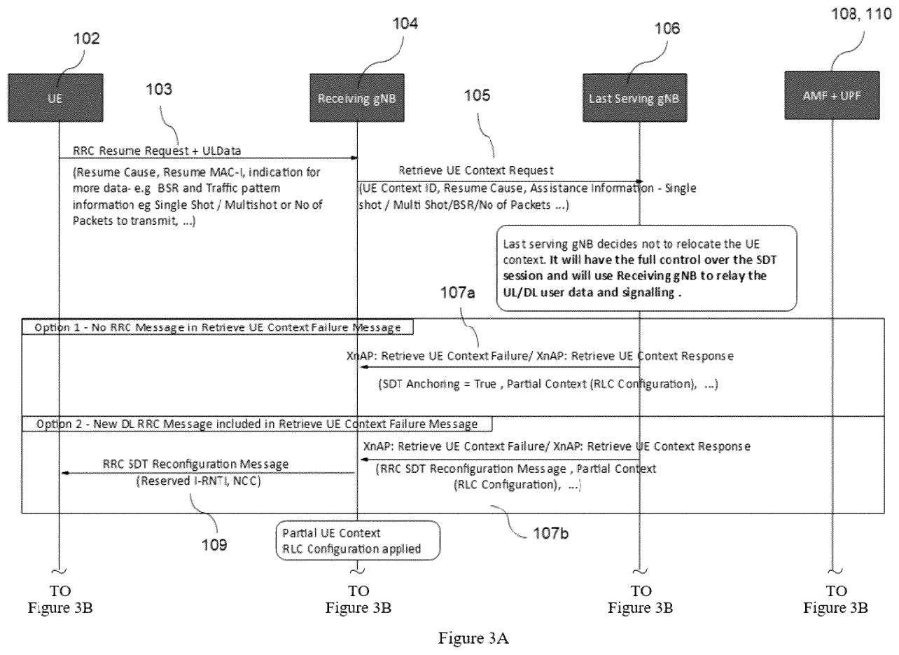

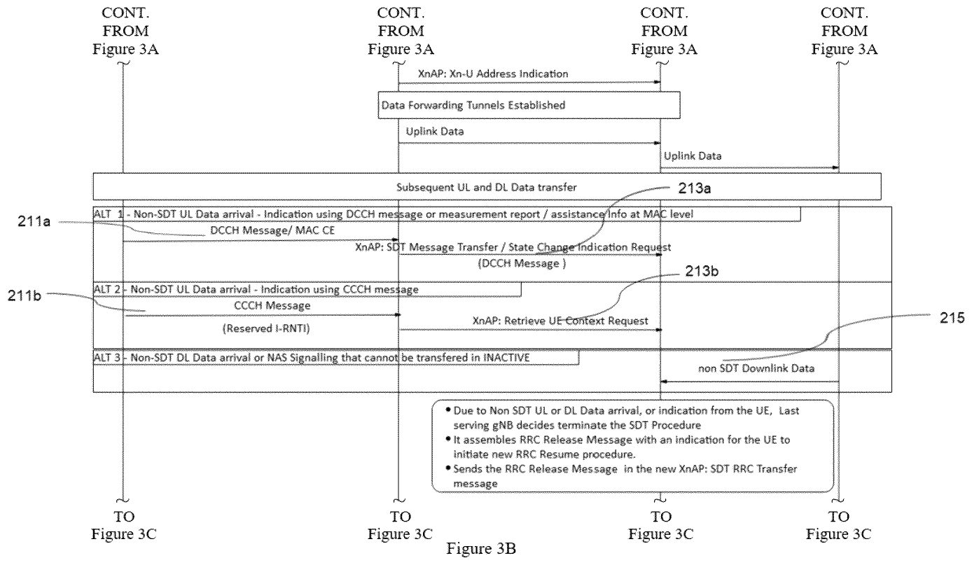

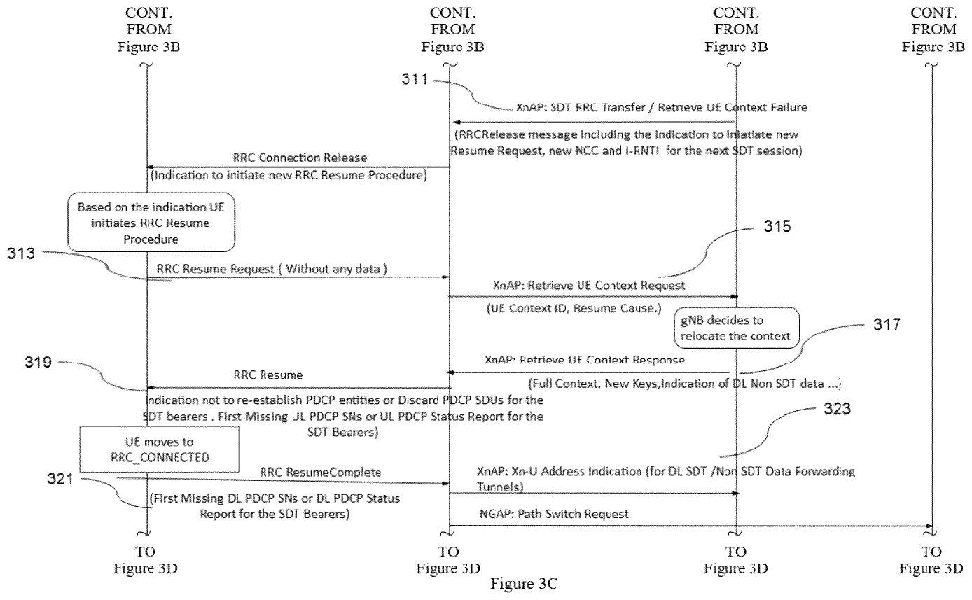

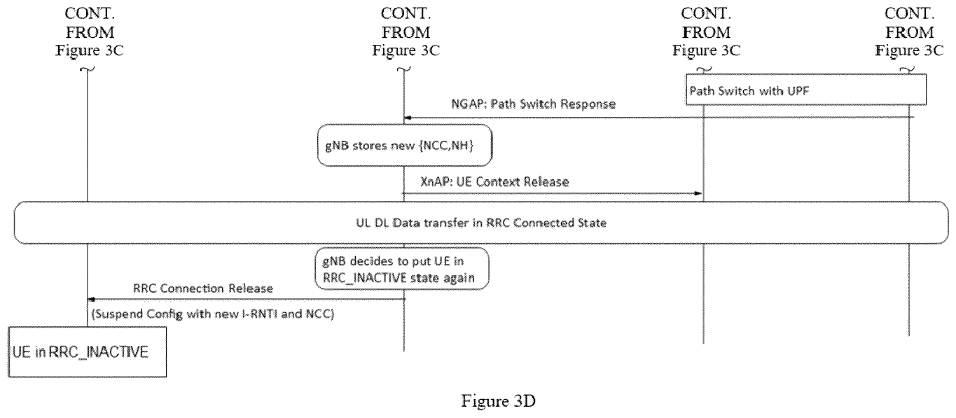

FIG. 3 shows an alternative communication flow between a user equipment (UE) 102, a target g Node B (gNB) 104, and a source g Node B (gNB) 106 for a similar example situation to that of FIG. 1. The network device may be referred to herein as a target node 104 or a source node 106 depending on whether the user device 102 is transferring to or from that network device respectively as part of a Cell Reselection or handover procedure.

In particular, FIG. 3 shows the communication flow with a multi shot non-anchor relocation followed by an anchor relocation of an alternative embodiment to the embodiment shown in FIG. 2.

The network device may be configured to operate as a source node 106 for a user device 102 which has transitioned from the source node 106 to a target node 104 during an ongoing communication session in a communications network. The source node 106 may be configured to receive an indication that the source node 106 cannot remain as being an anchor node of the ongoing communication session. The indication may be received from the user device 102 or the target node 104. In response to receiving the indication, to cause the user device 102 to transition from an inactive state to an active state and relocate user device 102 context from the source node 106 to the target node 104.

The source node 106 may be configured to receive the indication that the source node 106 cannot remain the anchor node of the ongoing communication session. In response to the indication, the source node 106 may terminate the current SDT procedure. The source node 106 may receive the indication from the user device 102 in a RRC message. Alternatively, or additionally, the source node 106 may receive the indication from the target node 104 via an Xn interface message that may be triggered from an RRC message received from the user device 102 or a MAC CE received from the UE. In case of MAC CE received from the user device 102, there is also an F1 interface message that may be used for signaling the indication from the DU to CU in the distributed architecture. Alternatively, or additionally, the source node 106 may receive the indication of the Downlink non-SDT Data arrival.

The source node 106 may be configured to generate and transmit an SDT RRC Transfer message or user device context failure message 311 to the target node 104 containing RRC Release message. The RRCRelease message contained in the SDT RRC Transfer message or user device context failure message 311 may comprise an RRCRelease message with an indication to initiate a new resume request message and/or procedure 313. The indication may also indicate to not suspend and/or reestablish PDCP entities for SDT radio bearers during the new resume procedure. The RRCRelease message contained in SDT RRC transfer request message 311 may comprise a new NCC and I-RNTI for a further SDT session.

The source node 106 may receive a retrieve user device context request 315 from the target node 104. In response to receiving the retrieve user device context request 315, the source node 106 may be configured to initiate relocation of the user device context. Additionally, or alternatively, the source node 106 may transmit an indication of downlink non-SDT data and uplink PDCP status reports 317 to the target node 104.

Alternatively, the network device may be configured to operate as a target node 104 for a user device 102 which has transitioned from a source node 106 to the target node 104 during an ongoing communication session in a communications network. The target node 104 may be configured to receive an indication from the source node 106 that the source node cannot remain as being an anchor node of the ongoing communication session.

The target node 104 may be configured to receive the indication from the source node 104 that the SDT session will be terminated. The indication may comprise downlink non-SDT data and uplink PDCP status reports 317.

The target node 104 may be configured to transmit to the user device 102 an RRCRelease message with an indication to initiate a new RRC resume procedure 319. The target mode may also be configured to receive an RRC resume request message 321 from the user device 102 in response to the indication to initiate a new RRC resume procedure 319.

The target node 104 may be configured to generate an RRC resume message 319 to be transmitted to the user device which comprises an indication not to re-establish packet data convergence protocol, PDCP, entities, or an indication to not discard PDCP service data units, SDUs for the SDT bearers, first missing uplink PDCP sequence numbers SNs or uplink PDCP status report for SDT bearers.

The target node 104 may be configured to receive an RRC resume complete message 321 from the user device 102. The target node 104 may be configured to generate and transmit an Xn-U address indication message 323 in response to the RRC resume complete message 321 from the user device 102. The Xn-U address indication message 323 may comprise the address for establishing downlink SDT or non-SDT data forwarding tunnels.

The user device 102 may be configured to transmit an indication to the target node 104 when transitioning from a source node 106 to the target node 104 during an ongoing communication session. The indication may indicate that the source node 106 cannot remain as being an anchor node of the ongoing communication session.

The user device 102 may be configured to receive the indication to initiate a new RRC resume procedure 319 from the target node 104. In response to the indication to initiate a new RRC resume procedure 319, the user device may initiate the RRC resume procedure by transmitting the RRC resume request message 321 to the target node 104 or the source node 106. The contents of the RRC resume request message 321 may be sent to the node that is currently the anchor node.

The user device 102 may be configured to receive the New DL RRC SDT Resume message 319 or RRC SDT Reconfiguration message 107 as general reconfiguration message used during SDT. This general reconfiguration message may carry any signaling from the network to the user device 102 during the SDT procedure. This may include the System Information Block in response to the SIB Request made by the UE.

During the procedure described in FIG. 3, the anchor gNB (node) may have full control of the SDT session and the receiving gNB (node) mainly acts as the relay to transfer the signaling and the data between the UE and the last serving gNB (anchor gNB) until the context is transferred.

Due to the following events, the last serving gNB, while anchoring, may decide to relocate the context to the receiving gNB (i) non SDT UL Data or UL NAS message arrival which cannot be transferred using SDT or due to deterioration of radio conditions during SDT and the indication through DCCH message or MAC CE message, (ii) non SDT UL Data arrival and the indication through CCCH or MAC CE message, or (iii) Non-SDT DL Data or NAS Signaling arrival (iv) due to internal triggers in the target node such as change in radio conditions or cell load in the current cell.

The data and signaling between the UE and the last serving gNB may be encrypted and integrity protected using the existing AS key until that the last serving gNB decided to bring the UE to RRC Connected mode and relocate the context to receiving gNB.

The last serving gNB may decide to terminate the ongoing SDT procedure. The last serving gNB may send the RRC Release message to the UE with a flag to initiate another RRC Resume procedure and an indication to not suspend the PDCP entities for the SDT radio bearers. The use of the flag in RRC Release message may be advantageous if the gNB has DL SDT data or DL non SDT data which could not be sent when the SDT procedure was aborted. With this flag the gNB can request the UE to initiate the SDT procedure either again (for remaining DL SDT data) or initiate legacy resume (in case of non SDT Data arrival) and transmit the pending DL Data without paging the UE. This will have the same effect as if the UE received the Paging message with its identity included in the Paging message and initiates the RRC Resume procedure with the appropriate “resume cause”.

An alternative mechanism to the above is that the last serving gNB sends a paging message with the indication of non-SDT DL data and/or Mobile terminated DL data for SDT or non-SDT to the UE after the sending RRC Release message. When the UE sends second RRC Resume Request based on the indication, it will not include any data along with the message.

The XnAP: Retrieve UE Context Response from the anchor gNB may include an indication that SDT session was terminated abruptly (eg Indication of Non SDT DL Data arrival) and PDCP Status report for the SDT DRBs. Based on this indication the new Serving gNB may include an indication in RRC Resume message not to re-establish the PDCP entities for or discard PDCP SDUs for the SDT Bearers. Additionally, it can include the UL PDCP Status report for the UE.

The RRC Resume Complete message may include the DL PDCP Status report for the SDT DRBs to have lossless transition to RRC Connected State and to minimize duplicated transmission on the air interface.

The XnAP: Xn-U Address Indication message that is sent may include the information for establishing data forwarding tunnels for SDT and Non SDT RBs.

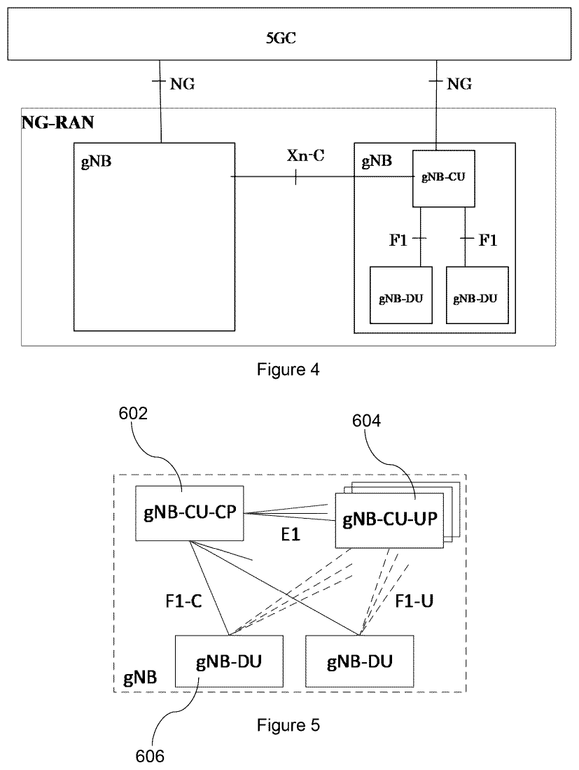

FIGS. 4 and 5 show schematic diagrams of possible distributed internal configurations of the network devices operating as target nodes 104 and source nodes 106. If the network device does not have a distributed structure, then it may operate as a single unit, which is not shown in FIG. 4 or 5.

When the network devices have a distributed structure the gNBs may be interconnected through the Xn interfaces. A gNB may consist of a gNB-CU 502, 504 and one or more gNB-DU(s) 506. A gNB-CU and a gNB-DU are connected via an F1 interface. The gNB-CU and connected gNB-DUs are only visible to other gNBs and the 5GC (5G Core Network) as a gNB. A gNB may consist of a gNB-CU-CP 502, multiple gNB-CU-Ups 504 and multiple gNB-DUs 506. The gNB-CU-UP is connected to the gNB-CU-CP through the E1 interface.

Any of the network devices of the above described scenarios may be a distributed network node comprising at least one control plane control unit 502, one or more user plane control units 504, and one or more distributed units 506, each control unit is configured to interface with each distributed unit via an F1 interface, and the control plane control unit is configured to interface with each of the one or more user plane control units via an El interface, wherein the network device is configured to send interface messages comprising the configuration data of the user device across the interfaces between units.

The proposed approach includes the introduction of new procedures and the modification of existing procedures over Uu, F1, E1 and Xn interfaces to make them suitable for supporting dedicated configuration for the UE during anchor relocation or while anchoring during a multishot SDT

Any indications from the user device such as MAC CE may be first received in the DU and may be transferred to the CU using an equivalent F1 interface message in the distributed architecture.

Any indications, such as not to suspend or reestablish the PDCP entities for the SDT radio bearers, shall also be transferred from the CU-CP to CU-UP on the E1 interface.

Each of the exemplary embodiments shown in FIGS. 1 to 3, and the possible distributed internal configurations of the network devices shown in FIGS. 4 and 5 aim to provide a new solution to resolve the signaling and security issues during anchoring. Handling of different cases without anchor relocation during multishot SDT procedure is described, including the signaling of RRC messages during anchoring. The exemplary embodiments may include the introduction of new procedures and the modification for existing procedures over Uu, F1, E1 and Xn interface to make them suitable for supporting anchoring functionality during multishot SDT. Since the RRC Release message terminates the SDT procedure it may not be used in the Xn Retrieve UE context Failure while anchoring and instead a new DL RRC message called RRC SDT Reconfiguration is proposed while anchoring during multi shot Small Data Transmission procedure. The issue of security keys being exposed in multiple gNB during anchoring is also addressed.

The following are standards specifications that may be found of assistance to the understanding of the present invention:
3GPP TS 38.300:“NR; NR and NG-RAN Overall Description, Stage 2”.
3GPP TS 38.304:“NR; User Equipment (UE) procedures in Idle mode and RRC Inactive state”.
3GPP TS 38.331:“NR; Radio Resource Control (RRC); Protocol specification”.
3GPP TS 38.423:“NG-RAN; Xn Application Protocol (XnAP)”.
3GPP TS 38.413:“NG-RAN; NG Application Protocol (NGAP)”.
3GPP TS 33.501:“Security Architecture and Procedures for 5G System”.

The phrase “configured to” or “arranged to” followed by a term defining a condition or function is used herein to indicate that the object of the phrase is in a state in which it has that condition, or is able to perform that function, without that object being modified or further configured.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A network device configured to operate as a source node for a user device which has transitioned from the source node to a target node during an ongoing communication session in a communications network, the source node configured to transmit an indication to the target node, wherein the indication indicates that the source node will remain as being an anchor node for the user device during the ongoing communication session.

2. The network device as claimed in claim 1, wherein the source node is configured to generate the indication as a part of a retrieved user device context response message transmitted from the source node to the target node.

3. The network device as claimed in claim 1, wherein the source node is configured to generate the indication as a Boolean flag within the retrieved user device context response message.

4. The network device as claimed in claim 1, wherein the source node is configured to generate the indication as a part of a downlink radio resource control (RRC), small data transmission (SDT), reconfiguration message within the retrieved user device context response message.

5. The network device as claimed in claim 4, wherein the source node is configured to generate the radio resource control (RRC), small data transmission (SDT) reconfiguration message comprising one of reserved or new inactive Radio Network Temporary Identifier, (RNTI, I-RNTI), and next hop chaining counter (NCC), to be received by the user device via the target node.

6. The network device as claimed in claim 1, wherein the source node is configured to generate and transfer one of an RRC message or a non-access stratum, NAS message as a part of a retrieved user device context response message to the target node during a SDT communication session.

7. The network device as claimed in claim 1, wherein the source node is configured to terminate the ongoing communication session based on receiving from the user device one of either assistance information or an indication that the SDT communication session has been completed.

8. The network device as claimed in claim 1, wherein the source node is configured to terminate the ongoing communication session by generating a SDT RRC transfer message and transmitting the SDT RRC transfer message to the target node.

9. The network device as claimed in claim 8, wherein the SDT RRC transfer message comprises an RRC release message comprising a new NCC and I-RNTI for a further SDT communication session.

10. A network device configured to operate as a source node for a user device which has transitioned from the source node to a target node during an ongoing communication session in a communications network, wherein the source node is configured to receive an indication that the source node cannot remain as being an anchor node of the ongoing communication session and, in response to receiving the indication, to cause the user device to transition from an inactive state to an active state and relocate user device context from the source node to the target node.

11. The network device as claimed in claim 10, wherein the source node is configured to, in response to receiving the indication, generate at least one new key for the target node to continue the ongoing communication session as the anchor node.

12. The network device as claimed in claim 10, wherein the ongoing communication session in a communications network is implemented via a small data transmission (SDT), procedure and the indication indicates that the ongoing communication session cannot continue as an SDT communication session.

13. The network device as claimed in claim 12, wherein the source node is configured to generate and transmit to the target node the at least one new key as a part of an uplink radio resource control (RRC) small data transmission (SDT) reconfiguration message encoded with the currently used key.

14. A user device configured to receive an indication from a target node when transitioning from a source node to the target node during an ongoing communication session, the indication indicating that the source node will remain as being an anchor node of the ongoing communication session.

15. The user device as claimed in claim 14, wherein the user device is configured to receive a radio resource control (RRC) small data transmission (SDT) reconfiguration message, the RRC SDT reconfiguration message comprising reserved inactive Radio Network Temporary Identifier (I-RNTI) and reserved next hop chaining counter (NCC) values.

16. A user device as claimed in claim 14, configured to transmit an indication to a target node when transitioning from a source node to the target node during an ongoing communication session, the indication indicating that the source node cannot remain as being an anchor node of the ongoing communication session.

17. The user device as claimed in claim 16, wherein the user device is configured to receive at least one new security key in a radio resource control, (RRC) small data transmission (SDT) reconfiguration message for use by the user device when communicating with the target node.

18. The user device as claimed in claim 16, wherein the user device is configured to receive an indication to initiate a new RRC resume procedure from the source node via the target node and in response initiate the RRC resume procedure by transmitting an RRC resume request message to the target node.

19. The user device as claimed in claim 16, wherein the user device is configured to generate and transmit an RRC resume complete message comprising the first missing one of downlink PDCP SNs or downlink PDCP status report for the SDT bearers to the target node.

20. The user device as claimed in claim 16, wherein the user device is configured to initiate a new RRC resume procedure as if it has received paging message with its identity included in the Paging message and in response initiate the RRC resume procedure by transmitting an RRC resume request message with appropriate resume cause value set to the target node.
